(19) United States
(12) Patent Application Publication
(10) Pub. No.: US 2026/0021832 A1
(43) Pub. Date: Jan. 22, 2026

(54) Method for Operating A Driver Assistance System, Driver Assistance System, And Motor Vehicle Having Such A Driver Assistance System

(71) Applicant: Volkswagen Aktiengesellschaft, Wolfsburg (DE)

(72) Inventors: Carsten Othmer, Braunschweig (DE); Markus Mrosek, Gifhorn (DE)

(73) Assignee: Volkswagen Aktiengesellschaft, Wolfsburg (DE)

(21) Appl. No.: 18/997,119

(22) PCT Filed: May 23, 2023
(86) PCT No.: PCT/EP2023/063843

§ 371 Date: Jan. 20, 2025

(30) Foreign Application Priority Data
Jul. 19, 2022 (DE) 10 2022 207 332.0

(51) Int. Cl. B60W 60/00; B60W 50/00

(52) U.S. Cl. CPC B60W 60/00272; B60W 50/0098; B60W 2555/20

(57) ABSTRACT

The disclosure relates to a motor vehicle, to a driver assistance system, and to a method for operating the driver assistance system. A relevant slipstream region of a further motor vehicle driving in a predetermined surrounding region of the motor vehicle is detected. A current slipstream efficiency is ascertained based on whether the motor vehicle is driving in the slipstream region and, if so, based on which of the slipstream partial regions of the slipstream region the motor vehicle is driving in. An overall aerodynamic efficiency is ascertained based on a current driving speed of the motor vehicle and the current slipstream efficiency. An individual overall aerodynamic efficiency potential that characterizes an overall aerodynamic efficiency that will be achieved by the motor vehicle when same drives in the slipstream region of the further motor vehicle is assigned to the further motor vehicle based on the driving speed and slipstream region.

### CROSS-REFERENCE TO RELATED APPLICATIONS

This application claims priority to German Patent Application DE 10 2022 207 332.0, filed on Jul. 19, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The present disclosure relates to a method for operating a driver assistance system and to a driver assistance system that is configured to carry out the method.

A motivation is that today's users of purely electrically drivable/propellable motor vehicles often fear that a current charge state and/or an available charging capacity of a main battery of the electric vehicle is not enough to meet the requirements of the user for a minimum driving range. Known solutions for reducing users' “range anxiety” are conventional range monitoring systems, which do indeed already display options for saving electrical drive energy to the driver (for example, an operating recommendation for the air conditioning, seat heating, etc.), giving the user a certain amount of control over the remaining range. However, a significant influencing factor in long journeys, i.e., the aerodynamics, is not currently addressed. Although modern motor vehicles are generally equipped with a plurality of sensors by means of which it is possible to comprehensively capture the state of the corresponding motor vehicle and the vehicle surroundings thereof, only little information is output to the driver or, respectively user of the motor vehicle with regard to the (current) aerodynamics of the motor vehicle. Nevertheless, the air resistance of a motor vehicle influences the energy consumption of the motor vehicle and does so to an ever-greater extent as the driving speed increases and is even the main influencing factor from a vehicle-specific limit speed upwards.

### SUMMARY

A need exists to further lower a drive energy demand of motor vehicles. The need is addressed by the subject matter of the independent claim(s). Embodiments of the invention are described in the dependent claims, the following description, and the drawings.

### BRIEF DESCRIPTION OF THE DRAWINGS

FIG. 1 shows a schematic example view of a motor vehicle (ego motor vehicle) comprising a driver assistance system as well as a perspective view of a surrounding region of the ego motor vehicle detected by means of the driver assistance system, wherein further example motor vehicles are driving in the surrounding region;

FIG. 2 shows an example electronic image representing the further example motor vehicles in the surrounding region of the motor vehicle and the overall ego aerodynamic efficiency potentials thereof;

FIG. 3 shows the example electronic image representing a current slipstream efficiency and an overall aerodynamic efficiency of the ego motor vehicle;

FIG. 4 shows an alternative embodiment of the example electronic image for displaying the current slipstream efficiency and the overall aerodynamic efficiency of the example ego motor vehicle; and

FIG. 5 shows an example efficiency journal and an option for representing same.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Features, benefits, and possible embodiments presented within the scope of the description for one of the subjects of the independent claims are to be regarded at least analogously as features, benefits, and possible embodiments of the relevant subject of the other independent claims and each possible combination of the subjects of the independent claims, in conjunction with one or more of the dependent claims, as the case may be.

According to the teachings herein, a method for operating a driver assistance system in a motor vehicle is proposed. In addition, a driver assistance system is proposed which is configured to carry out the method described herein or, respectively a possible embodiment thereof. Consequently, the driver assistance system comprises means for performing the method steps. Moreover, a motor vehicle is proposed which comprises the driver assistance system and which, in particular, may be controlled at least in part by means of the driver assistance system. The driver assistance system is accordingly a component of the motor vehicle if it is used in the intended installation position. In the following, the motor vehicle in which the method for operating the driver assistance system is carried out or, respectively which comprises the driver assistance system is referred to as the ego motor vehicle.

In the method, a slipstream region of a further motor vehicle driving in a predetermined surrounding region of the motor vehicle is detected. The number of further motor vehicles in the surrounding region of the ego motor vehicle is not limited to one; two or more further motor vehicles can be detected. At least some of the surrounding region lies ahead of the ego motor vehicle. In addition, the surrounding region can comprise a part behind the ego motor vehicle, and/or a part next to the ego motor vehicle. For example, the further motor vehicle can be detected if it is driving behind the ego motor vehicle and is catching up therewith and/or is driving next to the ego motor vehicle. For example, sensors of the ego motor vehicle, in particular camera, radar, laser, and/or lidar sensors, are used to detect the (relevant) further motor vehicle. Beneficially, recourse can be had to sensors already installed in the ego motor vehicle, so that the sensors installed in the ego motor vehicle beneficially serve, on the one hand, as sensors for the driver assistance system described herein and, on the other hand, as sensors for further vehicle functionalities (speed-dependent distance control system, lane keeping assist, etc.). The detected surrounding region or, respectively objects located therein, in particular the at least one further motor vehicle, can be fully analyzed in the surrounding region. For example, a plurality of alternative ego vehicle positions can be evaluated with regard to an energy efficiency for driving the ego.

A current slipstream efficiency is ascertained based on whether the motor vehicle is driving in the slipstream region or in one of the slipstream regions and, if applicable, based on which of the slipstream partial regions of the corresponding slipstream region the ego motor vehicle is driving in. In other words, it is firstly checked whether the ego motor vehicle is driving in the slipstream region or not and whether the current slipstream efficiency can already be ascertained based on this. If it was established that the ego motor vehicle is driving in the slipstream region, it is then checked as to which of the slipstream partial regions of the corresponding slipstream region the ego motor vehicle is driving in. This is because the relevant slipstream region comprises two or more slipstream partial regions. The relevant slipstream partial region can differ from another slipstream partial region of the same slipstream region, for example, on account of different air flow conditions, different legal requirements, etc.

In the method, an overall aerodynamic efficiency is further ascertained based on a current driving speed of the ego motor vehicle and the current slipstream efficiency. Since the air resistance force counteracting the forward movement of the ego motor vehicle increases quadratically with an increase in the current driving speed of the ego motor vehicle, a substantial proportion of a drive force with which the ego motor vehicle is driven in driving operation is allotted (at least from a particular driving speed upwards) to compensate for or, respectively overcome the air resistance force.

An individual overall aerodynamic efficiency potential that characterizes an overall aerodynamic efficiency that will be achieved by the ego motor vehicle when the ego motor vehicle drives in the slipstream region of the relevant further motor vehicle is assigned to the relevant further motor vehicle based on the driving speed and slipstream region thereof. The slipstream region of the relevant further motor vehicle is, in particular, dependent on an outer shape or, respectively body shape of the corresponding further motor vehicle-coupé, sedan, camper van, station wagon, convertible (open/closed), off-road vehicle or, respectively SUV, truck, bus, etc.-as well as on the outer dimensions thereof (length, width, height), on the superstructure shape (box, tarpaulin frame, tank, etc.), on whether the corresponding further motor vehicle is pulling a towed vehicle as a towing vehicle, on whether and, if yes, which externally fitted parts, for example tuning parts, spoiler, etc., the further motor vehicle comprises, on a chassis height setting of the further motor vehicle, etc.

A legally prescribed and speed-dependent minimum safety distance that must be maintained by the ego motor vehicle from a vehicle driving directly in front is in particular influential on the ascertaining or, respectively assignment of the vehicle-specific overall aerodynamic efficiency potential of the relevant further motor vehicle. This minimum safety distance results from the current driving speed of the corresponding further motor vehicle, since the driving speed of the further motor vehicle driving in front must be assumed for the ego motor vehicle in order to utilize the slipstream region. A directly adjoining first slipstream partial region behind the further motor vehicle extends, in particular, over a safety distance that must legally be maintained as a minimum from the further motor vehicle. Since the minimum safety distance to be maintained depends on the current driving speed, the longitudinal extent of the first slipstream partial region changes depending on the driving speed.

The teachings herein are based on an idea that driving in the slipstream of a vehicle driving in front reduces a drive power demand for overcoming/compensating for the air resistance force counteracting the forward movement of the ego motor vehicle and thus contributes to significant energy use savings and, consequently, to an increase in the electrical range. In particular in the case of drivers of purely electrically drivable motor vehicles that have a poor range as well as drivers of camper vans, it is common practice for them to position themselves behind a truck or bus over long distances. A so-called hypermiling community has sprung up, which has turned slipstream driving into an unofficial competition. Slipstream driving is promoted and simplified with the teachings herein. In addition, drivers of purely electrically drivable motor vehicles are encouraged to enter a slipstream and thus to learn and/or hone a particularly environmentally friendly driving style.

In some embodiments, a maximum achievable current slipstream efficiency that results in predetermined ideal conditions for the ego motor vehicle is determined. The current slipstream efficiency is provided as a percentage of the maximum achievable current slipstream efficiency. The ideal conditions characterize an ideal slipstream region and an ideal slipstream partial region of an ideal further motor vehicle. By way of example, the ideal conditions characterize a particularly voluminous further motor vehicle as an ideal further motor vehicle, in particular a truck, a bus, etc., which, due to its outer shape and dimensions, provides the ideal slipstream region which the ego motor vehicle could enter. The ideal slipstream region results from a current driving speed, in particular from the driving speed-dependent longitudinal extent of the first slipstream partial region. The ideal slipstream partial region is, in particular, a second slipstream partial region directly adjacent to the first slipstream partial region. For example, a 100-percent current slipstream efficiency is achieved with the ego motor vehicle if same is driving behind a suitable further motor vehicle classed as ideal, for instance a truck, and indeed in the ideal slipstream partial region, i.e., at a distance from the further motor vehicle that is no greater than the legally prescribed minimum distance. The ego motor vehicle is then in a so-called aerodynamic “sweet spot”, as a result of which a particularly large amount of drive energy can be saved. The further the ego motor vehicle deviates from this sweet spot (greater distance, a different further motor vehicle, etc.) the lower the current slipstream efficiency.

In some embodiments, a maximum achievable overall aerodynamic efficiency is ascertained depending on the individual overall aerodynamic efficiency potentials of the further motor vehicles and, based on the highest overall aerodynamic efficiency potential in the surrounding region of the ego motor vehicle, is provided as a percentage thereof. Therefore, the overall aerodynamic efficiency potentials of the further motor vehicles in the surrounding region of the ego motor vehicle are ascertained and then the highest overall aerodynamic efficiency potential of these is utilized as a reference value for providing the maximum achievable overall aerodynamic efficiency. In addition, the current overall aerodynamic efficiency that is currently being achieved by the ego motor vehicle is set in relation to the highest overall aerodynamic efficiency potential. The individual overall aerodynamic efficiency potentials of the further motor vehicles and the current overall aerodynamic efficiency are then provided as a percentage (1-100, 0.1-1, 0%-100%, etc.). Thus, the maximum achievable overall aerodynamic efficiency that can be achieved with the further motor vehicles currently located in the surrounding region is provided in a manner appropriate to the situation, instead of specifying an absolute value for the maximum achievable overall aerodynamic efficiency, which in real driving operation can only rarely be achieved and/or can only be achieved with difficulty. If these values are displayed-for example, graphically and/or as characters/numbers-to a user (in this case, for example, a driver of the motor vehicle equipped with the driver assistance system), acceptance of the driver assistance system is increased as a result.

In some embodiments, an electronic image which represents the further motor vehicle or the further motor vehicles in the surrounding region of the motor vehicle as well as the overall aerodynamic efficiency potentials thereof is provided to the user of the driver assistance system. The electronic image or, respectively the electronic pictorial representation of the further motor vehicles is provided to the user, by way of example, by means of a display apparatus inside the ego motor vehicle, for instance a vehicle infotainment system, an instrument cluster, a head-up display, and/or another display of the ego motor vehicle. In this way, the user is reliably informed of the overall aerodynamic efficiency potential of the further motor vehicles located in the surrounding region. It can be provided that the user calls up the representation of the further motor vehicles. Furthermore, it is conceivable for the representation of the further motor vehicles to be displayed in a periodically repeated or uninterrupted manner. As a result, the user, if they are the driver of the ego motor vehicle, can drive with the ego motor vehicle behind one of the further motor vehicles, i.e., in the slipstream region thereof, in order to save (more) drive energy. On account of the pictorial representation, the user can detect the situation of the further motor vehicles in the surrounding region particularly easily or, respectively with particularly little effort.

In some embodiments, the overall aerodynamic efficiency is provided in/on the image as a point in a graph, the first graph axis of which characterizes the current slipstream efficiency and the second graph axis of which characterizes the driving speed of the ego motor vehicle. The graph is, in particular, a color-coded characteristic map. Such a characteristic map representation of the overall aerodynamic efficiency makes it possible for the user to intuitively understand one or more significant influencing variables that have an influence on the aerodynamic efficiency of the ego motor vehicle and to implement suitable measures to save drive energy. By way of example, the user can easily recognize based on the graph or, respectively characteristic map representation that they must reduce the driving speed or increase the current slipstream efficiency (for example by driving behind another of the further motor vehicles) in order to save drive energy. For a particularly pronounced saving effect, the user must execute both measures, which they can equally recognize particularly easily based on the 2D representation of the graph. Alternatively or additionally, the current slipstream efficiency is visualized in the image 14 as a vertical bar in front of a pictorial representation of the ego motor vehicle, and/or the current slipstream and efficiency the overall aerodynamic efficiency are shown as a pointer deflection of a relevant pointer instrument.

In some embodiments, exactly one of the further motor vehicles represented by means of the electronic image is selected by means of a selection signal, and the ego motor vehicle is steered autonomously into the slipstream region of the selected further motor vehicle. This is because it can generally be provided for the ego motor vehicle described herein that same comprises a control apparatus which is adapted to autonomously or semi-autonomously control the ego motor vehicle in at least one autonomous driving operating mode periodically, continuously, and/or in a manner restricted to a driving situation (for example, only during highway travel, etc.) and in so doing take over longitudinal and lateral control of the ego motor vehicle.

It is in particular provided here that the selection signal is provided depending on a user input received from the user by means of a selection apparatus. In other words, the user makes the user input on the selection apparatus, which is part of the display apparatus for displaying the electronic image of the further motor vehicles or is at least coupled to said display apparatus. The display apparatus can accordingly be a touchscreen, wherein the user input is then a touch input that the user makes by tapping on the further motor vehicle of the further motor vehicles sought by them. It is equally conceivable for the selection apparatus and the display apparatus to not be spatially linked inside the ego motor vehicle, i.e., for the selection apparatus to be a rotary pushbutton, a touchpad, and/or another input apparatus of the ego motor vehicle. This gives the user a particularly simple option for selecting the further motor vehicle for example by them in order to have the ego motor vehicle enter the associated slipstream region. Particularly few thought processes and particularly few hand movements are required from the user for saving drive energy efficiently.

It is even easier for the user of the driver assistance system or, respectively for the user of the ego motor vehicle to save drive energy if-as provided in a further possible embodiment of the method-the selection signal is provided by means of an automatic selection routine of the driver assistance system based on the detected overall aerodynamic efficiency potentials of the further motor vehicles. Here, the selection routine can be carried out by means of the control apparatus, which provides the autonomous driving operating mode. Simply put, the driver assistance system automatically, i.e., without user involvement, selects one of the further motor vehicles and uses the individual overall aerodynamic efficiency potentials as the basis for the selection. In particular, the selection routine is created such that it automatically selects that one of the further motor vehicles that has the best overall aerodynamic efficiency potential. This provides a particularly efficient option for always driving with the ego motor vehicle in an environmentally friendly manner, namely in a particularly energy-efficient and/or low-emission manner. Some embodiments provide that, based on the selection signal, the selected further motor vehicle is provided with an item of information that the ego motor vehicle is about to enter the slipstream region of the further motor vehicle and/or is entering the slipstream region and/or has entered the slipstream region. This item of information can be provided, for example, by means of light signal communication (by a lighting system on the outside of the ego motor vehicle, by means of an infrared light element, etc.), by means of vehicle-to-vehicle communication (Car2Car), by means of vehicle-to-infrastructure communication (Car2X), by means of another wireless data communication (WLAN, internet via mobile communication, etc.). In particular, the further motor vehicle in question comprises a corresponding counterpart element, by way of example a data receiver, a data transceiver, etc., which is adapted to accept as an input signal the data signal that is provided by means of the ego motor vehicle that characterizes the item of information. In particular, it is provided that both the driver of the ego motor vehicle and the driver of the further motor vehicle receive a message in this regard if the ego motor vehicle has finished positioning itself in the slipstream region (for example, “platooning mode active”). In this way, traffic safety is increased, since a driver of the further motor vehicle is not surprised by the ego motor vehicle entering the slipstream region or driving in the slipstream region. In addition, the driver of the further motor vehicle can adjust their driving behavior to the ego motor vehicle driving behind them, by way of example accelerate less sharply, brake less sharply, etc.

In some embodiments, if the ego motor vehicle is driving in the slipstream region of the further motor vehicle or, respectively in one of the slipstream regions of the further motor vehicles, a compensation system is activated between the ego motor vehicle and the corresponding further motor vehicle, by means of which compensation system an amount of effort that is saved compared with a relevant solo journey for generating a relevant drive force is divided directly or indirectly between the motor vehicle and the further motor vehicle or, respectively the users or operators thereof. Such a compensation can take place, by way of example, if it has been arranged between the further motor vehicle and the ego motor vehicle that the further motor vehicle drives in front for a first period of time and/or for a first route section and the ego motor vehicle drives in front for a second period of time and/or for a second route section. It is also conceivable to alternate many times, in particular in a roundabout. In this context, the alternation (i.e., the associated driving maneuvers such as accelerating, braking, changing lanes, activating the turn signal, overtaking, etc.) can be carried out autonomously by means of the control apparatus. Moreover, it is conceivable for the compensation to be done financially, by way of example by means of a money transfer. This increases the acceptance of the slipstream driving, in particular by the vehicle of the vehicles involved that is driving in front.

In some embodiments, it is provided that a current position of an actuator by means of which a motor vehicle apparatus that influences an air resistance can be adjusted is evaluated in order to ascertain the current slipstream efficiency. By way of example, it is ascertained whether a window, a sunroof, a top, and/or an adjustable air inlet, etc., of the ego motor vehicle is/are fully open or fully closed or is/are arranged in a partially open position. Furthermore, it is possible to detect the position in which a flap element, for example a spoiler, is arranged and/or the height at which a height-adjustable chassis of the ego motor vehicle is set. If, for example, the (rear) spoiler is arranged in an extended position at a driving speed of the ego motor vehicle at which the spoiler provides no gains in terms of safety and/or dynamics, the spoiler has a deleterious effect on the aerodynamics of the ego motor vehicle and, consequently, on the current slipstream efficiency. Thus, the current position of the spoiler is included in the detection of the current slipstream efficiency; an unnecessarily extended spoiler leads to a lower current slipstream efficiency. The user of the driver assistance system or, respectively the driver of the ego motor vehicle can, for example, be encouraged to relinquish inefficient use of the motor vehicle apparatuses influencing the air resistance and/or to adjust said motor vehicle apparatuses into a more aerodynamic position for a better current slipstream efficiency.

In some embodiments, it is provided that the overall aerodynamic efficiency is stored in an efficiency journal at predetermined distance intervals and/or at predetermined time intervals during a journey of the motor vehicle, which efficiency journal is provided to the user of the driver assistance system. The efficiency journal is provided to the user, for example, after/upon completion of the journey and/or during the journey, by way of example by means of the display apparatus or a further/another provision apparatus of the ego motor vehicle. The efficiency journal characterizes, in particular, a total aerodynamic efficiency for the (ongoing or previously completed) journey, for example as a curve in a further graph, in which the overall aerodynamic efficiency is or has been plotted over the time and/or over the distance of the corresponding journey. This gives the user a simple instrument for reflecting on the journey with regard to an achieved efficiency.

In some embodiments, the efficiency journal is provided to the user by means of a display apparatus that is external to the ego motor vehicle. In other words, the efficiency journal can be provided to the user in that it is sent to a user-specific mobile device, for example a smartphone of the user, for instance as a text message, email, push notification, by means of an app, etc. As a result, the user can examine the overall aerodynamic efficiencies achieved and/or the total aerodynamic efficiency of the completed journey and reflect on the journey with regard to an achieved efficiency spatially independently of the ego motor vehicle. Regardless of whether the user obtains the efficiency journal by means of the ego motor vehicle or by means of the display apparatus external to the ego motor vehicle, the efficiency journal can alternatively or additionally be supplied to a further person, for instance a fleet manager, for evaluation. It can generally be provided in the method that only the further person obtains the efficiency journal.

Further features of the invention are apparent from the following description of the FIGS. and with reference to the FIGS. The features and combinations of features mentioned above in the description, as well as the features and combinations of features presented below in the description of the figures and/or just in the figures, can be used not only in the indicated combination in each case, but also in other combinations or by themselves without departing from the scope of the invention.

Specific references to components, process steps, and other elements are not intended to be limiting. Further, it is understood that like parts bear the same or similar reference numerals when referring to alternate FIGS.

A method for operating a driver assistance system 1, the driver assistance system 1, by means of which the method can be carried out, as well as a motor vehicle 2 that comprises the driver assistance system 1, are set out in the following in a joint description. The motor vehicle 2 is referred to as the ego motor vehicle 2 in order to distinguish it from further motor vehicles 3. The motor vehicle 2 or, respectively ego motor vehicle 2 is a passenger car in the present example.

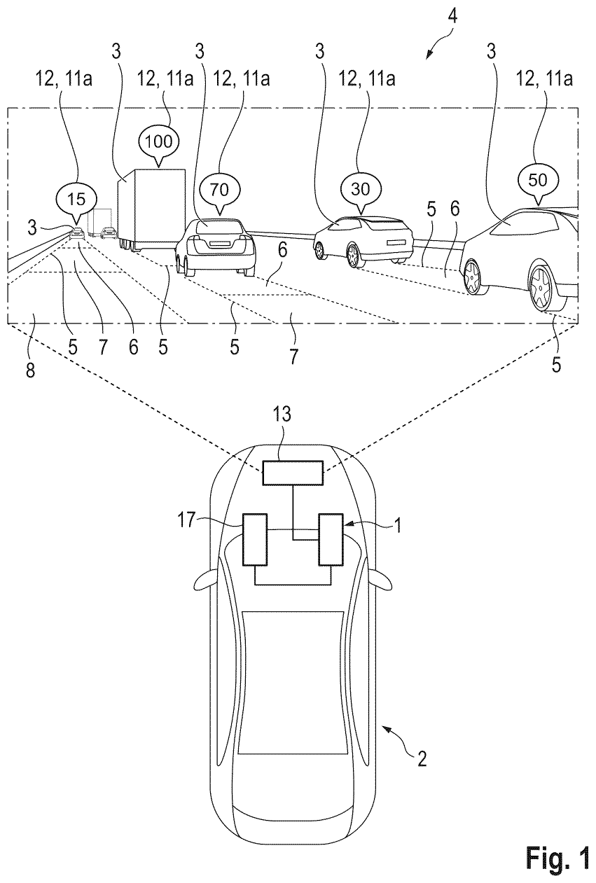

FIG. 1 shows a schematic view of the ego motor vehicle 2 comprising the driver assistance system 1 as well as a perspective view of a surrounding region 4 of the ego motor vehicle 2 detected by means of the driver assistance system 1, wherein the further motor vehicles 3 are driving in the surrounding region 4. In the method, a relevant slipstream region 5 of the relevant further motor vehicle 3 is detected, wherein the relevant slipstream region 5 comprises slipstream partial regions 6, 7, 8. A first slipstream partial region 6 directly adjoins the corresponding further motor vehicle 3, and a second slipstream partial region 7 directly adjoins the first slipstream partial region 6. The relevant slipstream region 5 can, in addition, comprise a third slipstream partial region 8 which directly adjoins the second slipstream partial region 7. The slipstream partial regions 6, 7, 8 thus differ from one another in terms of a relevant distance from the further motor vehicle 3. In addition, partial region-specific air flow conditions prevail in the slipstream partial regions 6, 7, 8. From a purely technical point of view, aerodynamically particularly favorable flow conditions prevail at least in the first two slipstream partial regions 6, 7. The slipstream partial regions 6, 7, 8 transition, in particular seamlessly, into one another and are not rigidly defined regions. They can change depending on the flow conditions and/or driving speed and are mainly utilized here as a simpler way to refer to spatial and flow-related conditions behind the corresponding further motor vehicle 3. Therefore, theoretically, if a motor vehicle is driving behind the corresponding further motor vehicle 3 in the first slipstream partial region 6, the motor vehicle driving behind benefits from the particularly favorable flow conditions that prevail in the first slipstream partial region 6. This is because the motor vehicle driving behind is exposed to particularly little oncoming air, since the air is displaced by the further motor vehicle 3. This idea is taken further in the method.

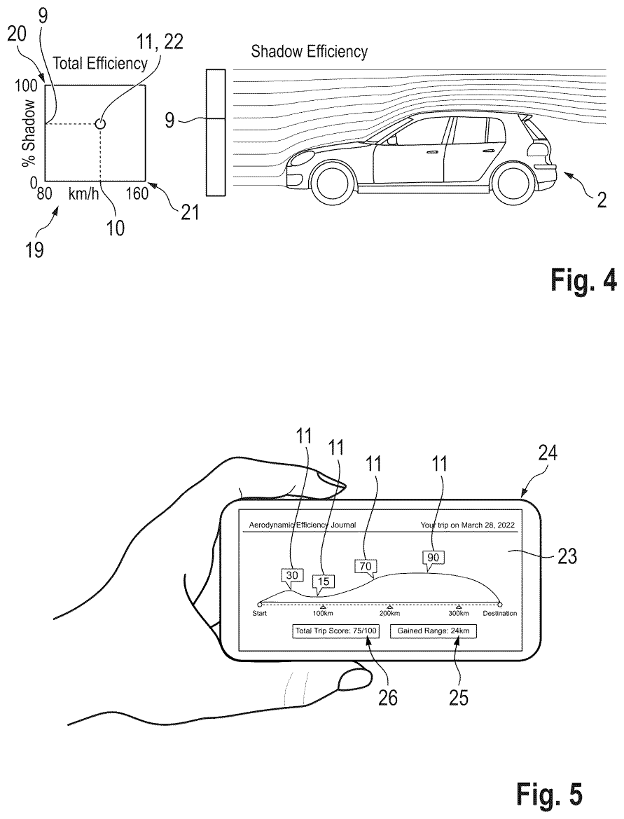

Specifically, in the method, a current slipstream efficiency 9 (see FIGS. 3 and 4) is, furthermore, ascertained on the basis of whether the ego motor vehicle 2 is driving in one of the slipstream regions 5 and, if applicable (i.e. if it was ascertained that the ego motor vehicle 2 is driving in one of the slipstream regions 5), on the basis of which of the slipstream partial regions 6, 7, 8 of the corresponding slipstream region 5 the ego motor vehicle 2 is driving in. If the ego motor vehicle 2 is driving, for example, particularly far behind the corresponding further motor vehicle 3, in particular in the third slipstream partial region 8, a correspondingly low current slipstream efficiency 9 applies. A correspondingly high, i.e. favorable, current slipstream efficiency 9 results when the ego motor vehicle 2 drives in the second slipstream partial region 8. In order to ascertain the current slipstream efficiency, in the present case, a current position of an actuator (not represented) is, in addition, evaluated, by means of which actuator a motor vehicle apparatus, for example a spoiler, a chassis, an air inlet, a window, a sunroof, etc., influencing an air resistance can be adjusted. An overall aerodynamic efficiency 11 (see FIGS. 3 and 4) is then ascertained based on a current driving speed 10 of the ego motor vehicle 2 and the current slipstream efficiency 9. Furthermore, an individual overall aerodynamic efficiency potential 12 that characterizes a potentially achievable overall aerodynamic efficiency 11a that will be achieved by the ego motor vehicle 2 when same drives in the slipstream region 5 of the relevant further motor vehicle 3 is assigned to the relevant further motor vehicle 3 based on the driving speed and slipstream region 5 thereof. The driver assistance system 1 comprises sensors 13 for detecting the further motor vehicles 3, the slipstream regions 5, the slipstream partial regions 6, 7, 8, etc.

Although, from a purely aerodynamic point of view, the most favorable flow conditions for the ego motor vehicle 2 prevail in the relevant first slipstream partial region 6 of each slipstream region 5, it is in particular provided in the method to output a warning against entering the relevant first slipstream partial region 6 and/or to prevent entry into the relevant first slipstream partial region 6, since the relevant first slipstream partial region 6 does not meet the requirements for a legally prescribed minimum safety distance that must be maintained by the ego vehicle 2 from the corresponding further motor vehicle 3. A lengthening of the first slipstream partial region 6 thus depends on the current driving speed of the further motor vehicle 3.

A maximum achievable current slipstream efficiency that results for the ego motor vehicle 2 in predetermined ideal conditions is determined here. The actual current slipstream efficiency 9 is provided as a percentage of the maximum achievable current slipstream efficiency. In the present case, the ideal conditions characterize a truck (see FIG. 1) as an ideal further motor vehicle 3, which truck provides a slipstream region 5 classed as ideal on account of its outer shape and dimensions. Therefore, in the present case, the ego motor vehicle 2 achieves a 100-percent current slipstream efficiency 9 if it thus drives behind the truck, and indeed in the ideal slipstream partial region thereof, in the present case in the second slipstream partial region 7 (concealed or, respectively occupied by a further motor vehicle 3 in FIG. 1). Because the ego motor vehicle 2 is driving in the second slipstream partial region 7, the minimum safety distance is automatically maintained, since a front end of the second slipstream partial region 7 is directly adjacent to the minimum safety distance. The ego motor vehicle 3 is then in an aerodynamic “sweet spot”, as a result of which a particularly large amount of drive energy can be saved.

In the present example, the maximum achievable overall aerodynamic efficiency 11a is ascertained depending on the individual overall aerodynamic efficiency potentials 12 of the further motor vehicles 3 and, based on the highest overall aerodynamic efficiency potential 12 in the surrounding region 4, is provided as a percentage thereof. See FIG. 1: the highest overall aerodynamic efficiency potential 12 is provided by the truck, so that the overall aerodynamic efficiency potential 12 thereof is fixed at 100% in the example. 70% of the overall aerodynamic efficiency potential 12 of the truck is provided by the compact car, 50% by the SUV, 30% by the sedan, and 15% by the vehicle represented on the far left.

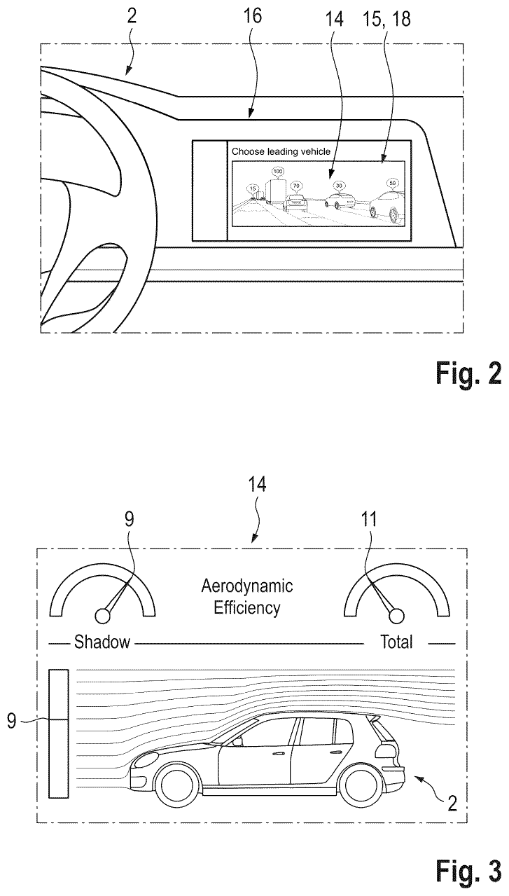

FIG. 2 shows an electronic image 14 representing the further motor vehicles 3 in the surrounding region 4 of the ego motor vehicle 2 and the overall aerodynamic efficiency potentials 12 thereof. In the method in the present example, the image 14 is provided to a user of the driver assistance system 1, here via a display 15—in the present case a touchscreen—of a vehicle infotainment system 16 of the ego motor vehicle 2. Accordingly, in the ego motor vehicle 2, the driver assistance system 1 and the display 15 and/or the vehicle infotainment system 16 are or can be coupled to one another, wherein the display 15 is adapted to pictorially display data provided by the driver assistance system 1. It is furthermore conceivable for the display 15 to be part of the driver assistance system 1.

In particular, exactly one of the further motor vehicles 3 represented by means of the electronic image 14 is selected by means of a selection signal, and the ego motor vehicle 2 is autonomously steered into the associated slipstream region 5 of the selected further motor vehicle 3. For this purpose, the ego motor vehicle 2 comprises a control apparatus 17 (see FIG. 1), the function of which is to provide an autonomous driving operating mode for the ego motor vehicle 2. The selection signal can, on the one hand, be provided depending on a user input received from the user by means of a selection apparatus 18. In the present case, the selection apparatus 18 is the display 15 which is embodied as the touchscreen. The user input is accordingly a tap input entered by the user into the selection apparatus 18 by them touching or, respectively tapping the touchscreen or, respectively the display 15 at the desired location, making a swiping gesture, etc. On the other hand, the selection signal can be selected by means of an automatic selection routine of the driver assistance system 1 based on the detected overall aerodynamic efficiency potentials 12 of the further motor vehicles 3. It is provided here, in particular, that that one of the further motor vehicles 3 in the surrounding region 4 that has the highest overall aerodynamic efficiency potential 12 is selected by means of the selection routine; in the present case, the truck is thus selected by the selection routine. Furthermore, it can be provided that the user selects another of the further motor vehicles 3 by means of the user input and thus overrides the automatic selection of the selection routine, by way of example if the user prefers to drive faster than the further motor vehicle 3 selected by means of the selection routine.

If the selection signal is/has been provided and, accordingly, the ego motor vehicle 2 is to be driven into the slipstream region 5 of the further motor vehicle 3, in the present case a first item of information is provided to the further motor vehicle that the ego motor vehicle 2 is about to enter the slipstream region 5 of the corresponding further motor vehicle 3. What is more, a second item of information is provided to the further motor vehicle 3 if the ego motor vehicle 2 has started to enter the slipstream region 5. Furthermore, in the present case, a third item of information is provided to the further motor vehicle 3 as soon as the ego motor vehicle 2 has entered the slipstream region 5.

If the ego motor vehicle 2 is driving in one of the slipstream regions 5 of the further motor vehicles 3, a compensation system is activated between the ego motor vehicle 2 and the corresponding further motor vehicle 3, by means of which compensation system an amount of effort that is saved compared with a relevant solo journey for generating a relevant drive force is divided directly or indirectly between the ego motor vehicle 2 and the further motor vehicle 3 or, respectively the users or operators thereof. If the ego motor vehicle 2 consumes, by way of example, 2% less drive energy due to driving in the slipstream region 5 of the further motor vehicle 3, it can be provided that the financial equivalent of 1% drive energy is transferred to the user/driver of the further motor vehicle 3. Alternatively or additionally, the effort saved can be compared between the ego motor vehicle 2 and the further motor vehicle 3 if the vehicles 2, 3 take turns driving in front.

FIG. 3 shows the electronic image 14 representing the current slipstream efficiency 9 and the overall aerodynamic efficiency 11 of the ego motor vehicle 2, so that the (human) user of the driver assistance system 1 can recognize particularly easily how aerodynamically efficiently the ego motor vehicle 2 is driving. The current slipstream efficiency 9 is visualized in a lower image region of the image 14 as a vertical bar in front of a pictorial representation of the ego motor vehicle 2. In addition, in an upper image region, the current slipstream efficiency 9 is shown as a pointer deflection of a stylized round or, respectively pointer instrument. The overall aerodynamic efficiency 11 is likewise represented as a pointer deflection of a further stylized round or, respectively pointer instrument.

FIG. 4 shows an alternative embodiment of the electronic image 14 for displaying the current slipstream efficiency 9 and the overall aerodynamic efficiency 11 of the ego motor vehicle 2, wherein a right and a left image region of the image 14 can be seen here. The right image region corresponds to the lower image region represented in FIG. 3. The left image region shows a two-dimensional graph 19, the first graph axis 20 of which (here the y-axis, as an example) characterizes the current slipstream efficiency 9. The second graph axis 21 (here the x-axis as an example) of the graph 19 characterizes the driving speed 10 of the ego motor vehicle 2. The overall aerodynamic efficiency 11 is displayed as a point 22 in the graph. In particular, the graph, which can, by way of example, be represented as a square, reproduces the dependence of the overall aerodynamic efficiency 11 on the two variables plotted on the axes by means of regions of different colors and/or by means of isolines in the characteristic map.

FIG. 5 shows an efficiency journal 23 and an option for representing same. This is because it is provided in the method in the present case that the overall aerodynamic efficiency 11 is stored in the efficiency journal 23 or, respectively as the efficiency journal 23 at predetermined distance intervals and/or at predetermined time intervals during a journey of the ego motor vehicle 2. The efficiency journal 23 is provided to the user of the driver assistance system 1. The efficiency journal 23 can be provided by means of the ego motor vehicle 2, in particular by means of the display 15 and/or another display apparatus of the ego motor vehicle 2. Here, a display apparatus 24 that is external to the ego motor vehicle, for example a mobile device such as a smartphone, a tablet, etc., serves as means for displaying the efficiency journal 23. In particular, a range gained compared with a solo journey-see reference sign 25-is displayed in the efficiency journal 23. Reference sign 26 denotes a display of a total efficiency value achieved by the user of the driver assistance system 1 with the journey.

The method for operating the driver assistance system and the driver assistance system itself each demonstrate a possibility for further lowering a drive energy demand of motor vehicles. Here, the present teachings focus on supporting a driver of the motor vehicle in order to utilize consumption-reducing and range-lengthening effects as best as possible. The functionality of the method or, respectively of the driver assistance system can, by way of example, be referred to as a slipstream assistant or aerodynamic efficiency assistant.

The basis of the proposed method or, respectively driver assistance system is detection of a 3D environment around the ego motor vehicle. The resulting detection data serve as input for an aerodynamic analysis that takes place as a real-time flow analysis or by reading out precalculated characteristic maps and tables by means of computer hardware installed in the vehicle or in a control center (for instance, a server apparatus, in particular a backend) that is in or can be brought into data communication with the driver assistance system. Results of this analysis are, in particular,
i. a current slipstream efficiency: for this purpose, an index is introduced, for example, as a percentage from 0 (solo journey without a vehicle driving in front) to 100 (travel behind a large vehicle, for instance, a truck or tour bus, etc., at a minimum safety distance therefrom or, respectively in the aerodynamic sweet spot thereof). The index depends on a shape of the vehicle driving in front (not only height and width, but also other aerodynamically relevant properties such as the shape of the rear, etc.) and on a distance from said vehicle.
ii. a current aerodynamic overall efficiency: this results depending on the slipstream efficiency index (see i.) and a current own vehicle speed and is indicated as a score, by way of example, likewise as a percentage between 0 and 100.
iii. an evaluation of vehicles recognized in the vehicle environment as potential lead vehicles according to the aerodynamic efficiency that can be achieved with them. Here, by way of example, a further score is used which can be graduated in the same or a similar manner to the score described under ii. The further score depends on an individual driving speed of the relevant potential lead vehicle, on the safety distance to be maintained resulting from the vehicle speed, and on a vehicle size, shape, and other significant aerodynamic vehicle properties.

In the interests of a functionality which is as instructive as possible, the slipstream efficiency index (i.), the aerodynamic overall efficiency (ii.), and the further score, by means of which a suitability evaluation of the potential lead vehicles or, respectively a rating thereof is performed (iii.), are visualized in a suitable manner, for example by means of a display apparatus in an instrument cluster of the ego motor vehicle, by means of a display apparatus of a vehicle infotainment system, etc.
The slipstream efficiency index is for example represented as a vertical bar in front of the visualized ego motor vehicle, together with correspondingly colored flow lines around the ego motor vehicle in order to represent a slipstream effect in a manner that is comprehensible to the user or, respectively driver.
The aerodynamic overall efficiency is represented, for example, as a point in a color-coded 2D characteristic map (depending on the speed of the ego vehicle and the slipstream efficiency index) and/or as a number. Such a characteristic map representation allows the driver to intuitively understand essential manipulated variables for the aerodynamic overall efficiency and derive suitable measures. Such a measure can, for example, be to reduce the driving speed or to search for a lead vehicle with a greater slipstream effect. For the latter, the “rating” of the lead vehicles in question (iii.) is visualized, i.e., represented pictorially to the driver.

In particular, all of the ascertained data are stored during the journey and can be retrieved and represented as a journal after the journey is complete. An overall score for the journey that was made and/or that is still ongoing and the gained range are calculated and represented. Equally, it is possible to transmit the journal to mobile terminals by means of a suitable app, to analyze the journal further, to share the journal on social media, in particular with the hypermiling community.

In the teachings herein it is particularly provided that a clear warning is output and/or a legally prescribed minimum safety distance from the vehicle driving in front is prevented from being breached by an automatic braking intervention. It would also be conceivable to provide a penalty for this breach in the form of a punitive deduction from the slipstream efficiency index actually achieved and/or to represent this breach in the journal as an educational measure for the driver.

If a lead vehicle is selected-by way of example, by means of a touch input, an operating gesture, etc.-in particular on a representation of a rating of the potential lead vehicles, it can be provided that an application is made to the lead vehicle by vehicle-to-vehicle communication, that the granting thereof is waited for, and that a payment system for helping to save energy is activated.

It is, in addition, conceivable, using suitably modified ACC and/or Car2Car communication, for the ego motor vehicle to move behind the selected lead vehicle, in particular into the corresponding slipstream region and, in so doing and in consideration of the legal minimum safety distance, to maintain a distance set by the driver. The drivers of both vehicles are informed, by way of example, of successful coupling by means of a message (for instance, a text display: “Platoon Mode Engaged” or the like).

If the ego motor vehicle provides a driving mode in which the ego motor vehicle is steered autonomously or semi-autonomously, the ego motor vehicle could independently move behind the selected lead vehicle.

Furthermore, other/further aerodynamically relevant circumstances (active aerodynamic components such as spoilers or diffusers, roof racks, open windows, etc.) can be included in the calculation of the own aerodynamic efficiency and the associated visualizations.

### LIST OF REFERENCE NUMERALS

1 Driver assistance system
2 Motor vehicle or, respectively ego motor vehicle
3 Further motor vehicle
4 Surrounding region
5 Slipstream region
6 Slipstream partial region
7 Slipstream partial region
8 Slipstream partial region
9 Current slipstream efficiency
10 Current driving speed of the ego motor vehicle
11 Overall aerodynamic efficiency
11a Potentially achievable overall aerodynamic efficiency
12 Individual overall aerodynamic efficiency potential
13 Sensors
14 Electronic image
15 Display
16 Vehicle infotainment system
17 Control apparatus
18 Selection apparatus
19 Graph
20 Graph axis
21 Graph axis
22 Point
23 Efficiency journal
24 Display apparatus external to the ego motor vehicle
25 Display of the gained range
26 Display of the total efficiency value

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

What is claimed is:

1-15. (canceled)

16. A method for operating a driver assistance system in a motor vehicle, comprising:
detecting a slipstream region of a further motor vehicle driving in a predetermined surrounding region of the motor vehicle;
ascertaining a current slipstream efficiency based on whether the motor vehicle is driving in the slipstream region and, if applicable, based on which of the slipstream partial regions of the slipstream region the motor vehicle is driving in;
ascertaining an overall aerodynamic efficiency based on a current driving speed of the motor vehicle and the current slipstream efficiency;
assigning to the further motor vehicle, based on the driving speed and slipstream region thereof, an individual overall aerodynamic efficiency potential that characterizes an overall aerodynamic efficiency that will be achieved by the motor vehicle when same drives in the slipstream region of the further motor vehicle.

17. The method of claim 16, comprising determining a maximum achievable current slipstream efficiency that results in predetermined ideal conditions for the motor vehicle, and providing the current slipstream efficiency as a percentage thereof.

18. The method of claim 16, comprising detecting a relevant slipstream region of a further motor vehicle driving in the surrounding region of the motor vehicle and ascertaining a maximum achievable overall aerodynamic efficiency depending on the individual overall aerodynamic efficiency potentials of the further motor vehicles and, based on the highest overall aerodynamic efficiency potential in the surrounding region, to provide a percentage thereof.

19. The method of claim 16, comprising providing to a user of the driver assistance system an electronic image which represents the further motor vehicle in the surrounding region of the motor vehicle as well as the overall aerodynamic efficiency potentials thereof.

20. The method of claim 19, wherein
the overall aerodynamic efficiency is provided in the image as a point in a graph, the first graph axis of which characterizes the current slipstream efficiency and the second graph axis of which characterizes the driving speed of the motor vehicle, and/or
the current slipstream efficiency is visualized in the image as a vertical bar in front of a pictorial representation of the ego motor vehicle, and/or the current slipstream efficiency and the overall aerodynamic efficiency are shown as a pointer deflection of a relevant pointer instrument.

21. The method of claim 19, wherein exactly one of the further motor vehicles represented by the electronic image is selected using a selection signal, and the motor vehicle is autonomously steered into the slipstream region of the selected further motor vehicle.

22. The method of claim 21, wherein the selection signal is provided depending on a user input received from the user by a selection apparatus.

23. The method of claim 21, wherein the selection signal is provided by an automatic selection routine of the driver assistance system based on the detected overall aerodynamic efficiency potentials of the further motor vehicles.

24. The method of claim 21, wherein, based on the selection signal, the further motor vehicle is provided with an item of information that the motor vehicle is about to enter the slipstream region of the further motor vehicle and/or is entering the slipstream region and/or has entered the slipstream region.

25. The method of claim 16, wherein, if the motor vehicle is driving in the slipstream region of the further motor vehicle, a compensation system is activated between the motor vehicle and the further motor vehicle, using which compensation system an amount of effort that is saved compared with a relevant solo journey for generating a relevant drive force is divided directly or indirectly between the motor vehicle and the further motor vehicle.

26. The method of claim 16, wherein a current position of an actuator using which a motor vehicle apparatus that influences an air resistance can be adjusted is evaluated in order to ascertain the current slipstream efficiency.

27. The method of claim 16, wherein the overall aerodynamic efficiency is stored in an efficiency journal at predetermined distance intervals and/or at predetermined time intervals during a journey of the motor vehicle, which efficiency journal is provided to a user of the driver assistance system.

28. The method of claim 16, wherein the efficiency journal is provided to the user by a display apparatus that is external to the motor vehicle.

29. A driver assistance system, configured to:
detect a slipstream region of a further motor vehicle driving in a predetermined surrounding region of the motor vehicle;
ascertain a current slipstream efficiency based on whether the motor vehicle is driving in the slipstream region and, if applicable, based on which of the slipstream partial regions of the slipstream region the motor vehicle is driving in;
ascertain an overall aerodynamic efficiency based on a current driving speed of the motor vehicle and the current slipstream efficiency; and to
assign to the further motor vehicle, based on the driving speed and slipstream region thereof, an individual overall aerodynamic efficiency potential that characterizes an overall aerodynamic efficiency that will be achieved by the motor vehicle when same drives in the slipstream region of the further motor vehicle.

30. A motor vehicle having a driver assistance system designed of claim 29.

31. The driver assistance system of claim 29, configured to determine a maximum achievable current slipstream efficiency that results in predetermined ideal conditions for the motor vehicle, and to provide the current slipstream efficiency as a percentage thereof.

32. The driver assistance system of claim 29, configured to detect a relevant slipstream region of a further motor vehicle driving in the surrounding region of the motor vehicle and to ascertain a maximum achievable overall aerodynamic efficiency depending on the individual overall aerodynamic efficiency potentials of the further motor vehicles and, based on the highest overall aerodynamic efficiency potential in the surrounding region, to be provided as a percentage thereof.

33. The driver assistance system of claim 29, configured to provide to a user of the driver assistance system an electronic image which represents the further motor vehicle in the surrounding region of the motor vehicle as well as the overall aerodynamic efficiency potentials thereof.

34. The driver assistance system of claim 33, wherein
the overall aerodynamic efficiency is provided in the image as a point in a graph, the first graph axis of which characterizes the current slipstream efficiency and the second graph axis of which characterizes the driving speed of the motor vehicle, and/or
the current slipstream efficiency is visualized in the image as a vertical bar in front of a pictorial representation of the ego motor vehicle, and/or the current slipstream efficiency and the overall aerodynamic efficiency are shown as a pointer deflection of a relevant pointer instrument.

35. The driver assistance system of claim 33, wherein exactly one of the further motor vehicles represented by the electronic image is selected using a selection signal, and the motor vehicle is autonomously steered into the slipstream region of the selected further motor vehicle.
